(19) United States
(12) Patent Application Publication
(10) Pub. No.: US 2025/0192474 A1
(43) Pub. Date: Jun. 12, 2025

(54) CLAMP FOR RELIEVING A CABLE ON AN ELECTRICAL PLUG

(71) Applicant: Hella GmbH & Co. KGaA, Lippstadt (DE)

(72) Inventors: Frank Fortströer, Delbrück (DE); Burkhard Misselwitz, Salzkotten (DE)

(21) Appl. No.: 18/975,671

(22) Filed: Dec. 10, 2024

(30) Foreign Application Priority Data
Dec. 11, 2023 (DE) 102023134588.5

(51) Int. Cl. H01R 13/58

(52) U.S. Cl. CPC H01R 13/5812; H01R 2201/26

(57) ABSTRACT

A clamp relieves tension to at least one cable on an electric plug or connector. The end of the cable is in a housing for the plug or connector. At least one electric wire in the cable is connected to at least one contact on or in the plug or connector. The clamp encompasses the housing and the cable. A pressed fit connection is obtained between the cable and a clamping part of the clamp such that forces acting on the cable are deflected into the housing by the clamp.

### CROSS REFERENCE

This application claims priority to German Application No. 10 2023 134588.5, filed Dec. 11, 2023, the entirety which is hereby incorporated by reference.

### FIELD OF THE INVENTION

The present invention relates to a cable tension relief clamp on an electric plug or connector. The invention also relates to an assembly that contains this clamp and the use thereof in a motor vehicle lighting device.

### BACKGROUND OF THE INVENTION

Relief devices, in particular for relieving tension, forming mechanical safeguards for electric wires, are known from the prior art. These absorb and/or deflect forces acting on the cable in order to prevent them from being pulled out of a plug. When used where they are exposed to vibrations, these relief devices also counteract corrosion or a loss of contact in the contact means in a plug-in connection, because they suppress vibrations in the cable.

By way of example, EP 1 916 747 A1 discloses a tension relieving plug on the end of a cable with an injection molded housing, in which a tension relieving element is placed on the surface of the cable, which is coated by this housing under pressure.

DE 10 2011 051 951 A1 discloses a plug with a housing and a tension reliever for a cable inserted into the housing, which has two latching elements, each of which has a recess, and can be inserted from opposite sides into the housing or a guide on the housing. The latching elements interact with one another such that they encompass the cable in their recesses in the manner of a clamp, thus deflecting tension acting on the cable to the housing.

These relief devices are already integrated in the plugs during the production process, or the plugs are designed to accommodate these relief devices.

### BRIEF SUMMARY OF THE INVENTION

The object of the invention is to create an alternative design for a device for relieving tension in at least one cable on an electric plug or electric connector, which can be easily placed on the plug or connector after production thereof. A plug or connector is a part of a plug-in connection on the end of a cable that has contacts that project outward or are on the inside thereof.

The technical teachings of the invention disclose that the clamp is designed to encompass the housing for the plug or connector, and the end of a cable therein, in which a pressed fit connection between the cable and a clamping part of the clamp can be formed such that forces acting on the cable can be deflected to the housing by the clamp.

The invention is based on the idea of creating a relief device in the form of a clamp that can be placed on the outside for subsequently securing cables to basically any type of plug or connector. By encompassing the cable in the clamp, a pressed fit connection is obtained that deflects axial forces, i.e. forces along the length of the cable, in particular tensions, into the clamp. The clamp is preferably shaped to fit the cable such that a sufficient contact surface area is obtained. Any radial forces caused by rotation or vibration of the cable are deflected into the clamp by the radial form fit. A pressed fit connection is also formed between the housing for the plug or connector and this clamp. Consequently, the end of the cable in the housing is substantially decoupled mechanically from the rest of the cable, such that no significant forces can be transferred from the cable to the contacts in the plug or connector connected thereto.

In particular, the clamp has a first and second jaw connected to one another by a hinge. This makes it particularly easy to attach to the cable and the plug or connector.

By way of example, the hinge is a living hinge. This type of hinge is formed by a flexible, thin groove between the two jaws, without additional mechanical parts. The function of the hinge is assumed by this groove, where the clamp is substantially thinner. In particular, the jaws and living hinge form an integral plastic component. By way of example, polypropylene can be used to make a clamp with a living hinge due to its suppleness and elasticity. It can be produced in an injection molding process, or with a 3D printing process.

Advantageous embodiments of the clamp have latching means with which the jaws can be snapped together to encompass the housing and the cable. This makes the clamp easier to install. In particular, corresponding latching means are formed at the ends of the jaws away from the hinge, which snap together when the clamp is closed.

In another embodiment, the part of the clamp that surrounds the cable has at least one insert element on one of the jaws that comes in contact with the cable it encompasses, which is less elastic than the material from which the jaws are made. This insert element compensates for tolerances in the diameter of the cable such that the desired pressed fit connection is obtained between the cable and the clamp. This insert element can be made of rubber or plastic foam. In particular, the clamp has a total of two such insert elements, one of which is placed on each jaw. In this embodiment, the entire contact surface area encompassing the cable is formed by these insert elements.

In another embodiment, the clamp has at least one reference element that engages with a corresponding contact element on the housing when encompassing it. By way of example, the contact element forms a collar encircling the housing, and the reference elements on the jaws are formed by grooves corresponding thereto. When encompassing the housing, the collar fits into the grooves on the jaws. This reliably positions the clamp during assembly, while also obtaining a form fitting connection between the contact element and the reference elements with which axial forces can be transferred from the clamp to the housing, i.e. along the length of the cable.

The invention also relates to an assembly containing such a clamp and an electric plug or connector that has at least one cable, the end of which is in a housing for the plug or connector, in which at least one wire in the cable is connected to at least one contact in the plug or connector, and the clamp encompasses the housing and the cable, forming a pressed fit connection between the cable and the clamping part of the clamp, such that forces acting on the cable can be deflected to the housing by the clamp.

In particular, this assembly can be used in a plug-in connection with a socket or panel plug for a light module in a motor vehicle lighting device, in particular a headlamp, in which the plug-in connection connects the light module to a power source. These connections in motor vehicle lighting devices are subjected to vibrations and tremors when the vehicle is moving, and thus particularly prone to corrosion and contact losses. Combined with the high levels of electricity required by headlamps, these plug-in connections are subjected to the danger of electric arcs and the associated wear, resulting in a failure of the plug-in connection. For this reason, the invention proposes the use of the above assembly, comprising clamps and plugs or connectors in plug-in connections, to supply electricity to light modules in motor vehicle lighting devices.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1a shows the structure of an assembly obtained with the invention, in which the clamp is open.

FIG. 1b shows the structure of an assembly obtained with the invention, in which the clamp is open.

FIG. 2a shows the same assembly, with the clamp closed.

FIG. 2b shows the same assembly, with the clamp closed.

### DETAILED DESCRIPTION OF THE DRAWINGS

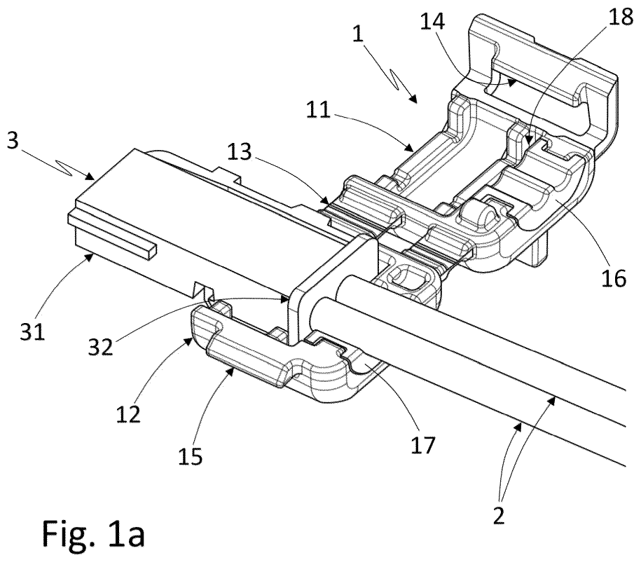

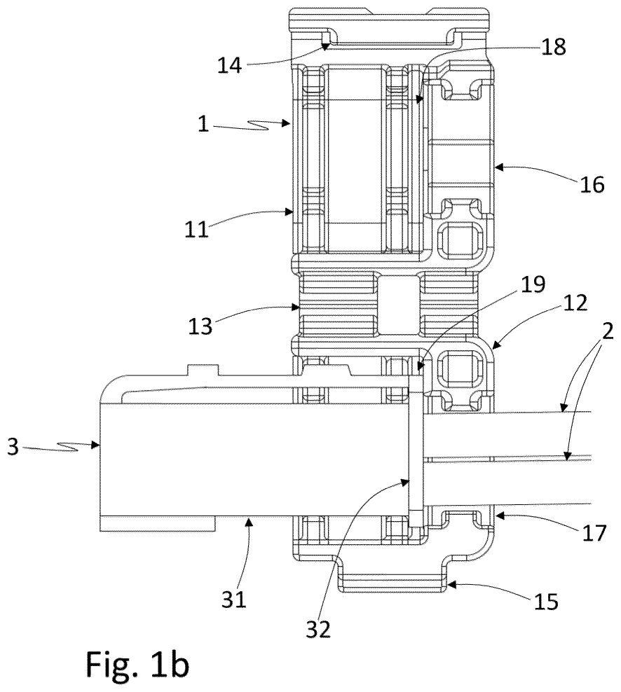

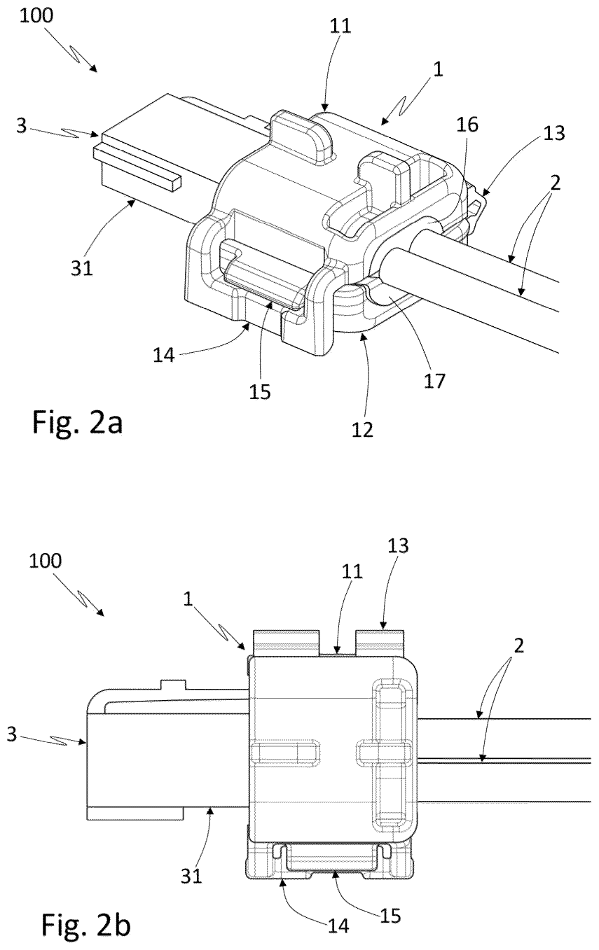

FIGS. 1a and 1b show the structure of an assembly 100 obtained with the invention, in which the clamp 1 is open, in a perspective view, and from above, and FIGS. 2a and 2b show the same views of the assembly 100, with the clamp closed.

The assembly 100 comprises the clamp 1 obtained with the invention, and the electric plug 3 with two cables 2, in which the ends of the cables 2 are in the housing 31, and electric wires in the cables 2 are connected to contacts in the plug 3 inside the housing 31. The closed clamp 1 encloses the housing 31 and cable 2, forming a pressed fit connection between the cable 2 and the clamping part of the clamp 1 such that forces acting on the cable 2 are deflected by the clamp 1 into the housing 31. The pressed fit connection transfers axial forces acting on the length of the cable 2, while radial forces are transferred from the cables 2 to the clamp 1 by the form-fitting connection.

The clamp 1 has a first jaw 11 and second jaw 12, which are connected to one another by a living hinge 13. The hinge 13 allows the clamp 1 to be closed (FIGS. 2a, 2b) once, from the open setting (FIGS. 1a, 1b). The jaws 11, 12 and hinge 13 are parts of an integral plastic component.

Latching means 14, 15 are integrally formed on the ends of the jaws 11, 12 away from the hinge 13, with which the jaws 11, 12 are snapped together to encompass the housing 31 and cable 2. The latching means 14, 15 are formed by a hook and a lip, which snap together when the clamp 1 is closed.

The clamping section has insert elements 16, 17 on each of the two jaws 11, 12, which come in contact with the cables 2 when closed. These insert elements 16, 17 have concave recesses that fit the cable 2. These insert elements 16, 17 are also made of a material that is less elastic than the material from which the jaws 11, 12 are made. When the clamp 1 is closed, these insert elements 16, 17 are compressed somewhat, resulting in a reliable pressed fit connection to the cables 2.

The grooves forming the reference elements 18, 19 on the jaws engage with a collar 32 forming a contact element 32 on the housing 31 when they are closed. This engagement between the reference elements 19 and the contact element 32 results in a secure seating of one end the clamp 1 on the housing 31, such that the clamp 1 can be closed without slipping out of position. Moreover, this form-fitting connection between the contact element 32 and the reference elements 18, 19 contributes to the transfer of forces from the clamp 1 to the plug 3 while relieving tension to the cable 2.

### List of Reference Symbols

1 clamp
11, 12 jaws
13 hinge
14, 15 latching means
16, 17 insert elements
18, 19 reference elements
2 cable
3 plug
31 housing
32 contact element
100 assembly

1. A clamp for relieving tension to at least one cable on an electric plug or connector, one end of the cable being in a housing for the plug or connector, at least one electric wire in the cable being connected to at least one contact on or in the plug or connector, the clamp comprising:
a clamping part deflecting forces acting on the cable into the housing, wherein the clamp encompasses the housing and the cable.

2. The clamp according to claim 1, further including a first jaw and second jaw, wherein the first jaw and the second jaw are connected to one another by a hinge.

3. The clamp according to claim 2, wherein the hinge is a living hinge.

4. The clamp according to claim 3, wherein the first jaw and the second jaw and hinge are parts of an integrally formed plastic component.

5. The clamp according to claim 2, further including latching means with which the first jaw and the second jaw are snapped together to encompass the housing and the cable.

6. The clamp according to claim 2, wherein a clamping section of the clamp contains at least one insert element on at least one of the first jaw or the second jaw that comes in contact with the cable when encompassing the cable, wherein the insert element is made of a material with a lower elasticity than the material from which the first jaw and the second jaw are made.

7. The clamp according to claim 6, wherein the clamping section contains two insert elements, one of which is placed on the first jaw and another of which is placed on the second jaw.

8. The clamp according to claim 1, further including at least one reference element, which engages with a corresponding contact element on the housing when enclosing the housing.

9. An assembly comprising:
a clamp according claim 1;
an electric plug or connector that has at least one cable,
wherein one end of the cable is inside a housing for the plug or connector,
wherein at least one electrical wire in the cable is connected to a contact on the plug or in the connector, and
wherein the clamp encloses the housing and cable, wherein a pressed fit connection is obtained between the cable and the clamping section of the clamp, such that forces acting on the cable are deflected into the housing by the clamp.

10. The assembly according to claim 9, wherein the assembly is used in a plug-in connection that has a socket or a panel plug for a light module in a motor vehicle lighting device, wherein the plug-in connection connects the light module to a power supply.
